(19) United States
(12) Patent Application Publication
(10) Pub. No.: US 2001/0037218 A1
(43) Pub. Date: Nov. 1, 2001

(54) System and method for providing prescription assistance for indigent patients using programs provided by pharmaceutical manufacturers

(76) Inventors: Donald R. Kaker, Grapevine, TX (US); Terry F. Schwarz, Capistrano Beach, CA (US); Brian T. Harper, Grapevine, TX (US)

Correspondence Address: SHLESINGER, ARKWRIGHT & GARVEY LLP, 3000 SOUTH EADS STREET, ARLINGTON, VA, 22202, US

(21) Appl. No.: 09/820,791

(22) Filed: Mar. 30, 2001

Related U.S. Application Data
(60) Provisional application No. 60/197,416, filed on Apr. 14, 2000.

(51) Int. Cl. G06F 17/60; G06F 17/30

(52) U.S. Cl. 705/2; 705/3; 707/104.1; 707/10

(57) ABSTRACT

An online system for providing prescription assistance for indigent patients using programs provided by pharmaceutical manufacturers comprises a web server connected to the internet; a database connected to the web server, the database including names of manufacturers of drugs providing prescription assistance to indigent patients and their respective application forms required to be filled out to participate in the programs; at least one workstation connected to the web server through the internet; and software operably associated with the web server and the database for searching the database for application forms by a user located at the workstation by selecting manufacturer name or drug name, for viewing the forms on a monitor, for filling out the forms for a patient and printing the forms for sending to the manufacturer.

### RELATED APPLICATION

This is a nonprovisional application claiming the priority benefit of provisional application Ser. No. 60/197,416, filed Apr. 14, 2000, which is hereby incorporated by reference.

### FIELD OF THE INVENTION

The present invention pertains to an online internet system designed to provide and track prescription assistance for indigent consumers provided by pharmaceutical manufacturers.

### BACKGROUND OF THE INVENTION

Information pertaining to prescription assistance programs provided by pharmaceutical companies is not readily available to the medical profession. This presents a problem to the provider of indigent medications. Since many of these providers are funded by donations and limited tax dollars, they do not have the staff or the funds to spend on searching out this information.

### OBJECTS AND SUMMARY OF THE INVENTION

The present invention provides an internet-based system to make it easier for medical professionals from organizations, such as mental health centers, social services, religious organizations, charities, non-profit clinics and community, county and state hospitals, to access letters, applications and forms from manufacturers of all drugs who offer assistance to indigent patients.

It is another object of the present invention to provide an internet-based system that can look up forms and applications by either manufacturer or drug, and give the user the option to either manually or automatically fill out the applications/form for a specific patient.

It is another object of the present invention to provide an internet-based system that provides secure user accounts with the ability to store patient and doctor information, track patient drug usage and monitor clinic status. Using these secure accounts and the database of information stored by the user, a participating medical professional can identify a patient who is need of free medication and the system will automatically assist in filling the manufacturer application forms (where applicable).

In summary, the present invention provides an online system for providing prescription assistance for indigent patients using programs provided by pharmaceutical manufacturers, comprising a web server connected to the internet; a database connected to the web server, the database including names of manufacturers of drugs providing prescription assistance to indigent patients and their respective application forms required to be filled out to participate in the programs; at least one workstation connected to the web server through the internet; and software operably associated with the web server and the database for searching the database for application forms by a user located at the workstation by selecting manufacturer name or drug name, for viewing the forms on a monitor, for filling out the forms for a patient and printing the forms for sending to the manufacturer.

The present invention also provides a method for providing prescription assistance for indigent patients using programs provided by pharmaceutical manufacturers, comprising:

a) establishing a database including names of manufacturers of drugs providing prescription assistance to indigent patients and their respective application forms required to be filled out to participate in the programs;

b) connecting the database online to a health care provider;

c) searching the database by the health care provider for an application form by selecting manufacturer name or drug name;

d) viewing the forms associated with selected manufacturer or drug on a monitor;

e) filling out the form of the selected manufacturer for a patient and printing the form for sending to the manufacturer.

These and other objects of the present invention will become apparent from the following detailed description.

### BRIEF DESCRIPTIONS OF THE DRAWINGS

FIG. 1 is a block diagram of an online prescription assistance program system made in accordance with the present invention.

FIGS. 2A-2C are site flowcharts for the online prescription assistance program system of the present invention.

FIGS. 3-12 are sample screen shots of the online prescription assistance program system of the present invention.

FIGS. 13-14 are sample web forms for specifying criteria for generating reports.

### DETAILED DESCRIPTION OF THE INVENTION

The present invention provides an internet-based system where:

The user belonging to an organization, such as a clinic, logs into the system with an assigned username and password. Once logged in, the user has immediate access to information on all patients and doctors previously stored by the organization.

The user searches a database of over 100 manufacturers and over 800 drugs to select the item for prescription.

If the patent or doctor information has not yet been stored, the user is given the option to do so.

The user then either manually or automatically fills the application/form for the selected item for prescription. A manual choice normally indicates the patient or doctor information is not recorded in the PAP database. An automatic choice (autofill) is used when the patient and doctor information has been previously stored.

After the selected manufacturer document is retrieved, the user scrolls through the application to make sure all data fields have appropriate entries. The user may then print the application/form to mail or fax it to the manufacturer.

Once the patient has been entered into the system database and has been selected for an autofill to a certain manufacturer, this information is transferred to the tracking database. Users can then analyze the type and amount of medication by patient as well as clinic savings by using the system.

For patients stored in the system database, several different types of reports are available, for example:

Running Totals for Clinic—Provides a detailed summary, by date range, of patients sorted by clinic name with a subtotal of the individual clinic and a grand total of all clinics.

Running Totals for Patients—Provides a detailed summary, by date range, for a specific patient with a total.

Expiration Report—Provides summary of medication expiration dates sorted by date, clinic and patient.

Renewal Report—Provides a summary of medication renewal dates sorted by date, clinic and patient.

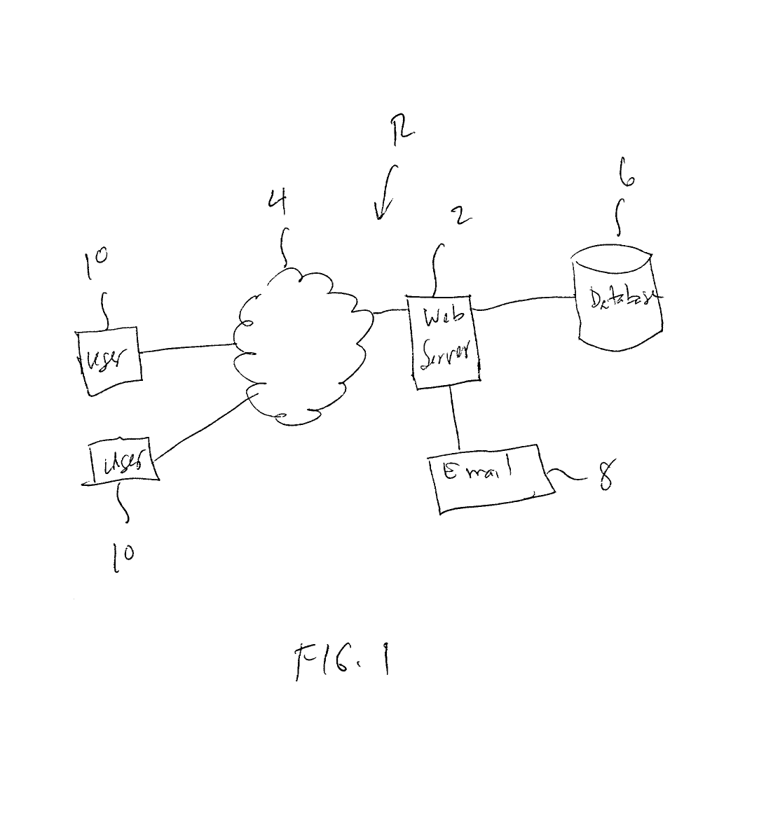

A prescription assistance program (PAP) system R made in accordance with the present invention is shown schematically in FIG. 1. The system R comprises a web server 2 running a server platform, such as the MICROSOFT NT 4.0, MICROSOFT Corporation. The major server services that enable the PAP system R are Internet Information Service 4.0, SQL Server 7.0 and SMTP mail services. The web server 2 is connected to a network 4, such as the Internet. A database subsystem 6 is operably to the web server 2 and is implemented with MICROSOFT SQL Server 7.0.

An e-mail subsystem 8 is integrated with the server 2 to enable e-mail transmissions and receipt at appropriate times in the implementation of the system R. Some e-mail transmissions are triggered by Active Server Pages (ASP) scripts when specific web pages are requested and processed. Other e-mail transmissions are commanded by user interaction on the site. A plurality of workstations 10 are connected to the server 2 via the network 4. The network station 10 is preferably a personal computer Pentium 300 MHZ or higher, 128 MB RAM, SVGA monitor capable of supporting 800×600 resolution, cable modem or DSL internet service, MICROSOFT INTERNET EXPLORER 5.0 or higher, Macromedia Flash 4.0 or higher, Acrobat Reader 4.0 or higher and printer.

The system R consists of the following software modules implemented in MICROSOFT WINDOWS.

Maintenance Module

Allowing the input of manufacturers information.

Allowing the input of drug names for which the manufacturer distributes.

Allowing the input of the forms by which the manufacturer requires to be filled out.

Database Module

Allows the user to search the database for forms by selecting manufacturer name of drug name.

Allows user to view form on screen.

Allows user to output form to printer.

The system R also includes web based programs consisting of the following software modules:

Admin Module

Allows the input of username and password for access to web based modules.

Member access. Allows users to login with rights to database web based modules.

Prescription Assistance Program (Forms) Module

Allows users to search database for forms by selecting manufacturer name or drug name.

Allows users to view form on screen.

Allows users to fill out from while viewing on screen.

Allows users to output completed form to printer.

Prescription Assistance Program (Tracking) Module

Allows users to input information about their patient.

Allows users to edit their existing patients,

Allows users to generate real time reports on patient activity.

The system R comprises over 40 hyperlinked web pages. These pages use the following technologies to produce dynamic content for the user accessing the site:

HTML: HyperTextMarkup Language is the primary programming medium used to author each page. The version of HTML implemented in MICROSOFT INTERNET EXPLORER (IE)v5.5. is the site baseline, although other browser versions (e.g., earlier Microsoft implementations of IE, Netscape browser) provide useable functionality as well.

ASP: Active Server Pages scripting is interspersed with the HTML code to enable real-time access information stored in the database whenever a particular page is requested by a user. ASP uses the object model in ACTIVEX Data Objects (ADO) to facilitate the creation, reading, updating and deletion of information stored in the database system.

JAVAScript and VBScript: Several embedded JAVAScript (Sun Microsystems) and VBScript (VISUAL BASIC) functions and scripts provide client-side dynamic features such as calendar displays and web form validation and error-checking.

The database subsystem 6 stores information on the following entities:

Users: A unique User ID identifies each entry. Information stored with each user includes Name, Organization, contact data, PAP Account with Access Code, and Sales data.

Doctors: A unique Doctor ID (for a given User) identifies each entry. Information stored with each doctor includes User ID, Name, Title, contact data and licensing data.

Patients: A unique Patient ID (for a given User) that identifies each entry. Information stored with each patient includes User ID, Name, contact data, Date of Birth, Age, Gender, Marital Status, Employment data and Income data.

Clinics: A unique Clinic ID (for a given User) that identifies each entry. Information stored with each clinic includes User ID, Name and contact data.

Manufacturers: A unique Manufacturer ID identifies each drug manufacturer. Information stored with each manufacturer includes Name and contact data(e.g., Address, Phone, Fax, etc.)

Drugs: A unique Drug Code identifies each entry. Information stored with each drug includes the Manufacturer ID, Generic Name, Strength, Units and Dosage.

Prescriptions: A unique Prescription ID identifies each entry. Information stored with each prescription includes Patient data, Doctor data, Drug data, Manufacturer data, and Clinic data as well as prescription details such as quantity, strength, directions, lot number, NDC number, refills, expiration date and renewal date.

Forms: A unique Form Name identifies each entry. Information stored with each form includes Manufacturer ID, Description, Page Length and FileName.

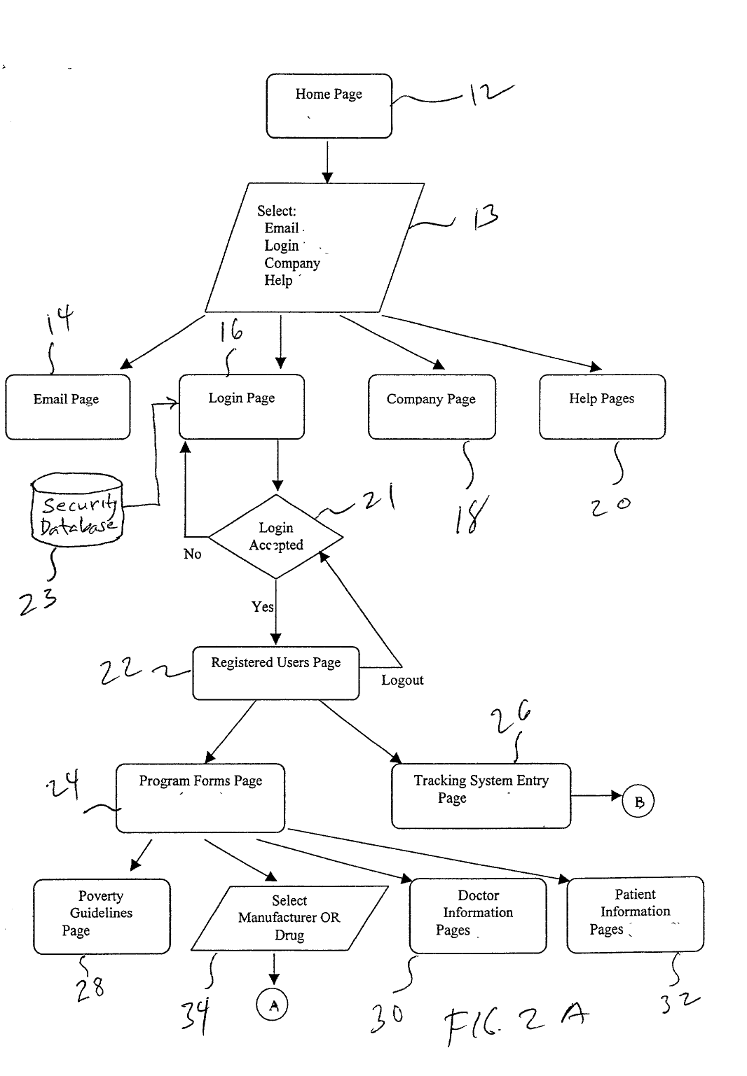

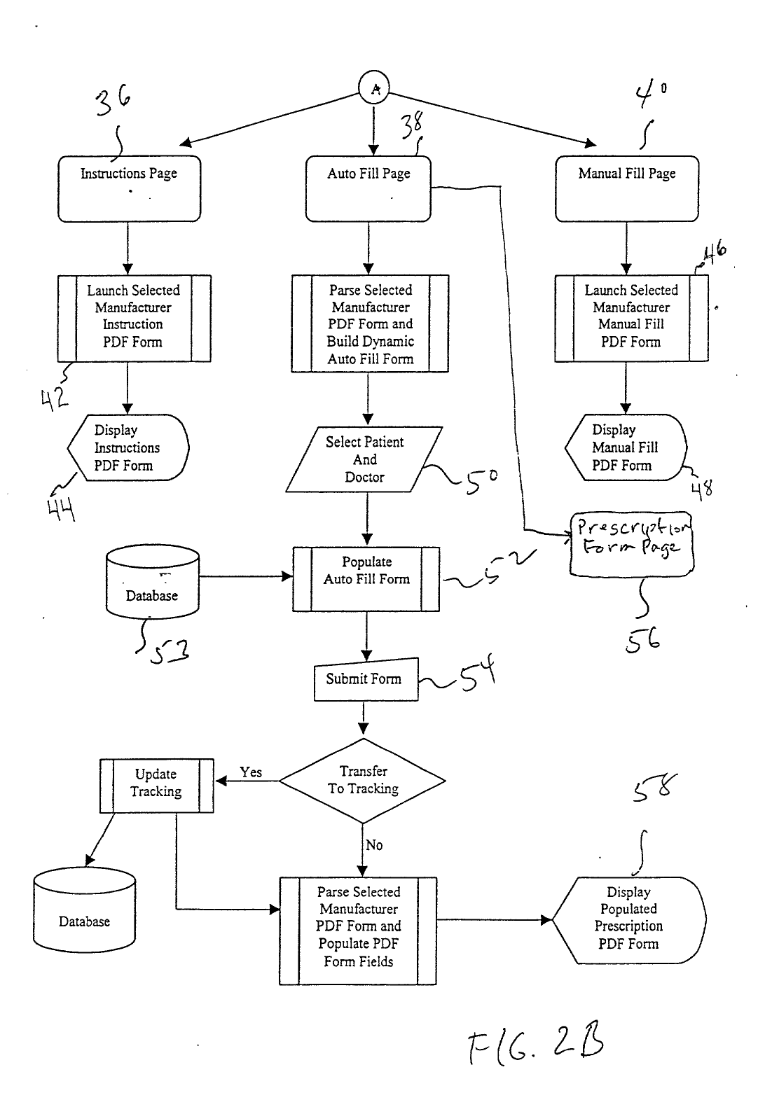

The site flowchart is disclosed in FIGS. 2A, 2B and 2C. A user by entering the website address is presented with a home page 12. The home page 12 is a default page and is a public access HTML-only page offering the following navigational choices and functionality shown at 13:

Contact the website owner for information on the Prescription Assistance Program (PAP) via a web form on the Email Page 14. This form is accessed by clicking either the “email form” choice on the menu or the “email form” hyperlink in the welcoming message.

Login into the site as a registered member (User) via a web form on the Login Page 16. This feature is accessed by clicking the “member access” choice on the menu.

Review information on the website owner. This feature is accessed by clicking the “company profile” choice on the menu. The visitor is sent to the Company Page 18.

Obtain help in using the features and functionalities of the site. This area is accessed by clicking the “help” choice on the menu. The visitor is sent to the Help Page 20.

The e-mail page 14 is a VBScript/HTML page presented to the user with the web form. The visitor is expected to fill in the form elements and submit the information to the site. VBScript functions validate the form element entries prior to form submission and, if required, provide error messages containing appropriate corrective action to the visitor if any form validation scripts fail. After filling in the form elements and submitting the information to the site, the Email subsystem integrates the information sent into an automatic email message to the website owner and sends the visitor to an email acknowledgment page. From this page, the visitor can elect (via menu choices) to visit the Home Page 12, Login Page 16, Company Page 18, or Help Page 20.

The login page 16 is an ASP/HTML page, which is the first of several web pages that are dynamically built by the web server after processing ASP scripts embedded in HTML. The web page returned to the user will vary depending on the results of the ASP processing generally indicated at 21, as follows:

Each time this page is requested, the ASP script searches for parameters accompanying the request that would indicate a previous failed login attempt.

If the script finds no such parameters (i.e., a first login attempt by a new visitor to the site), the server returns a page with a blank web form and a message requesting the user to enter an email address and password into the form elements.

If the script finds parameters indicating a failed login attempt, the server returns a page including the email address previously used in the failed attempt, a blank password, and a custom error message notifying the visitor of the reason for the failed attempt (“no email account found” or “invalid password”).

Each time a visitor submits the form to the site, the information entered in the login form is sent to another web page containing ASP code to validate the login attempt. The validation uses ADO technology to query user information in the SQL database 23, searching for a registered user with the email address and the password submitted.

If the combination is found in the database, the ASP script directs the following actions:

The user is allowed to enter the site and is sent to the Registered User page 22; and,

A variable is set to hold the User ID for remainder of the user's web session. This variable (called a session variable in ASP terminology) enables the web site to track the activities of this user among the many that could be logged into the site at the same time. Ech validated user receives a unique session variable for the length of their session.

If the combination is not found in the database, the ASP script redirects a loading of the login page and sends parameters with this request indicating a failed login attempt. This causes the “failed login” version of the page to be sent to the user to reinitiate the login process.

Using ASP scripts embedded in HTML web pages to make a single web page multi-functional is a technique frequently used in the system R to increase the efficiency and reusability of site components.

The company page 18 is an HTML-only page that describes the philosophy and mission of the website owner. The navigational choices presented to the user are similar to the menu choices on the homepage 12.

Help pages 20 are HTML-only pages that offer descriptions and explanations of the many site features and capabilities. Hyperlinks throughout the body of this page enable different named areas of the page to be immediately accessed. Approximately 20 different topics are covered to assist a visitor in using the site. At the bottom of this page, there is a hyperlink to a web site (WebTek.com) where a visitor can obtain troubleshooting assistance relative to the type and version of the browser they are using. The “exit help” menu choice returns the visitor to the Home Page 12.

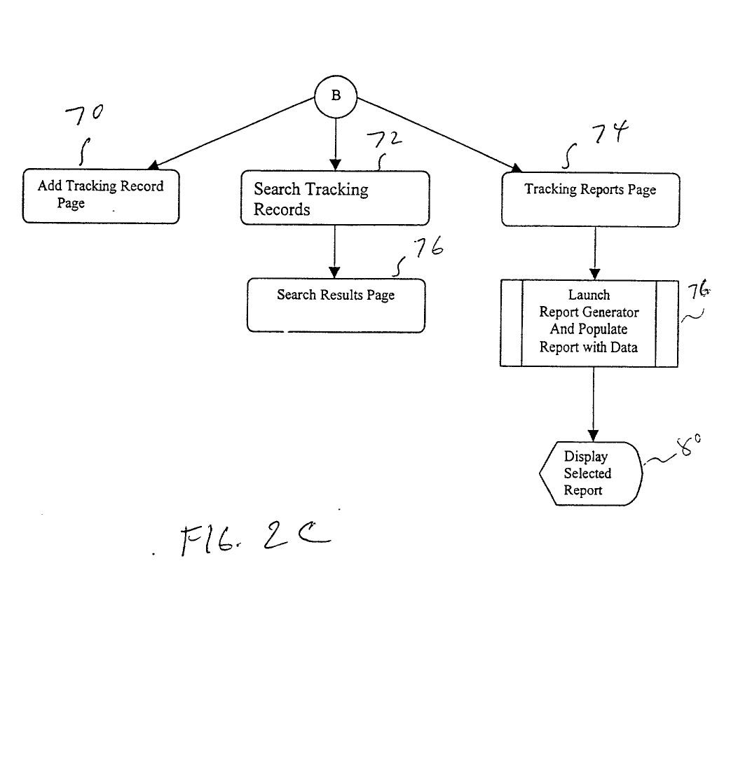

An example of a login page is shown in FIG. 3. Each user has a unique user name and password that is keyed to a company name. This allows multiple users to access patients entered by users that are keyed to a specific company. For example,

User 1-password 1-meddata

User 2-password 2-meddata

The above example shows that user 1 and user 2 are keyed to the company named Meddata and either user can view or edit any patient information entered by user 1 or user 2. Only patient information for company Meddata will be accessible to user 1 and user 2.

If the user login is accepted, the user is presented with registered users page 22. This page 22 is an ASP/HTML page and is the starting point for registered users of the site. Referencing the User ID session variable stored on the site, the web server uses ADO technology to query the SQL database user data. The server then builds a page to return to the user that includes a personalized greeting and three hyperlinked graphics that provides the following navigational choices:

Go to the Program Forms Page 24.

Go to the Tracking System Entry Page 26.

Return to the Login Page 16. (This choice will also clear the User ID session variable and require another Login to reenter the site.)

A similar personalization of returned web pages based on ADO/SQL retrieval of user data is repeated on the other pages in the site.

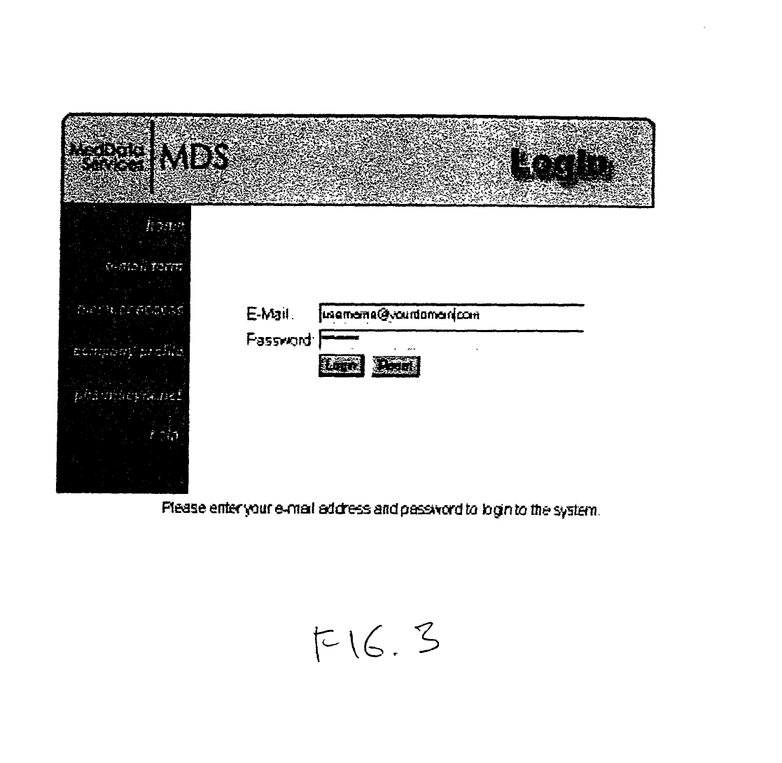

An example of a registered user page is shown in FIG. 4.

The program forms page 24 is an ASP/HTML page that includes Javascript functions to direct and manage several searching and page reloading features described below. When a user requests this page from any other pages on the site, the web server returns a page containing the following elements:

Three hyperlinked graphics providing navigational choices to:

Review poverty guideline on the Poverty Guidelines Page 28.

Add/Edit Doctor records accessed via the Doctor Information Page 30.

Add/Edit Patient records accessed via the Patient Information Page 32.

A manufacturer search and select feature implemented with a text box and a selection list, generally indicated at 34. The manufacturer selection list is built using ADO/SQL retrieval of all manufacturers stored in the database.

A drug search and select feature implemented with a text box and a selection list, generally indicated at 34. The drug selection list is built using ADO/SQL retrieval of all drugs stored in the database.

The search and select feature indicated at 34 for manufacturers uses Javascript functions as follows:

When the user enters characters into the text box and clicks the adjacent “Go” graphic, the select list is searched for a manufacturer name matching the entered characters. The first item in the manufacturer list with a match is then selected.

The search and select feature 34 for drugs is similarly implemented. Since each drug is related in the database to its manufacturer, selecting a drug is equivalent to selecting a manufacturer.

After the page is loaded the first time, clicking a choice in the manufacturer or drug select list runs a client-side Javascript function that reloads the page with additional elements, as follows:

A navigational button labeled “Instructions” is made visible to the user. Clicking this button accesses the Instruction Page 36 for the selected manufacturer.

If the manufacturer has a reference to an “Manual Fill Form” PDF file stored in the SQL database, a navigational button labeled “Manual Fill” is made visible to the user. Clicking this button accesses the Manual Fill Page 40 for the selected manufacturer.

If the manufacturer has an “Auto Fill” capability code stored in the SQL database, a navigational button labeled “Auto Fill” is made visible to the user. Clicking this button accesses the Auto Fill Page 38 for the selected manufacturer.

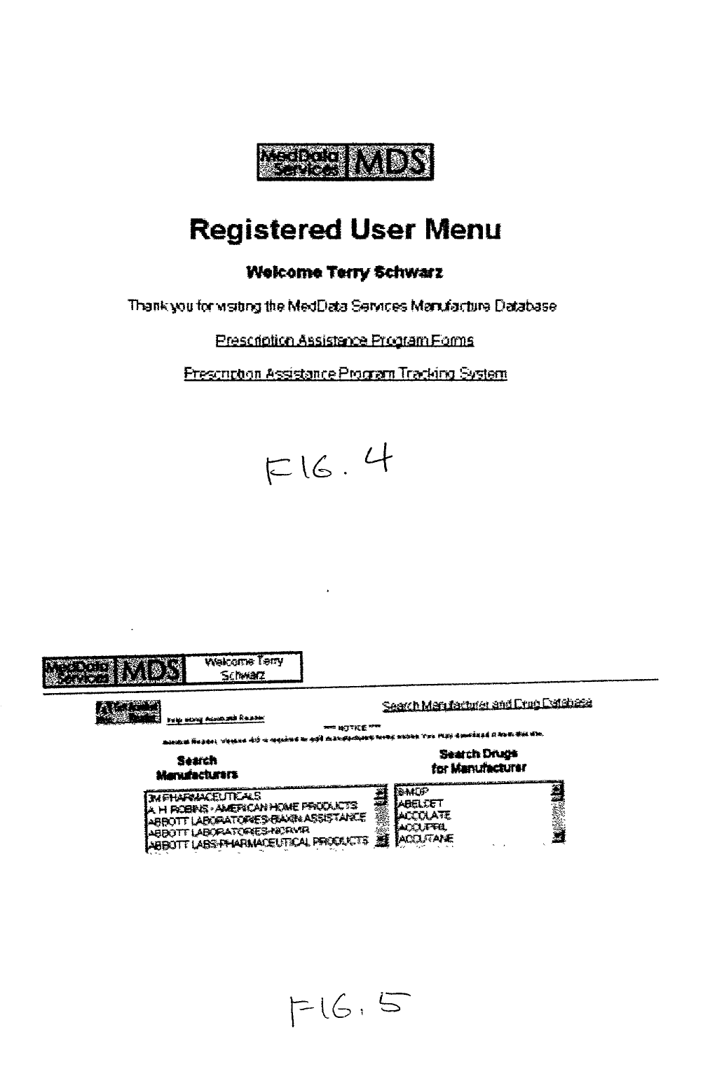

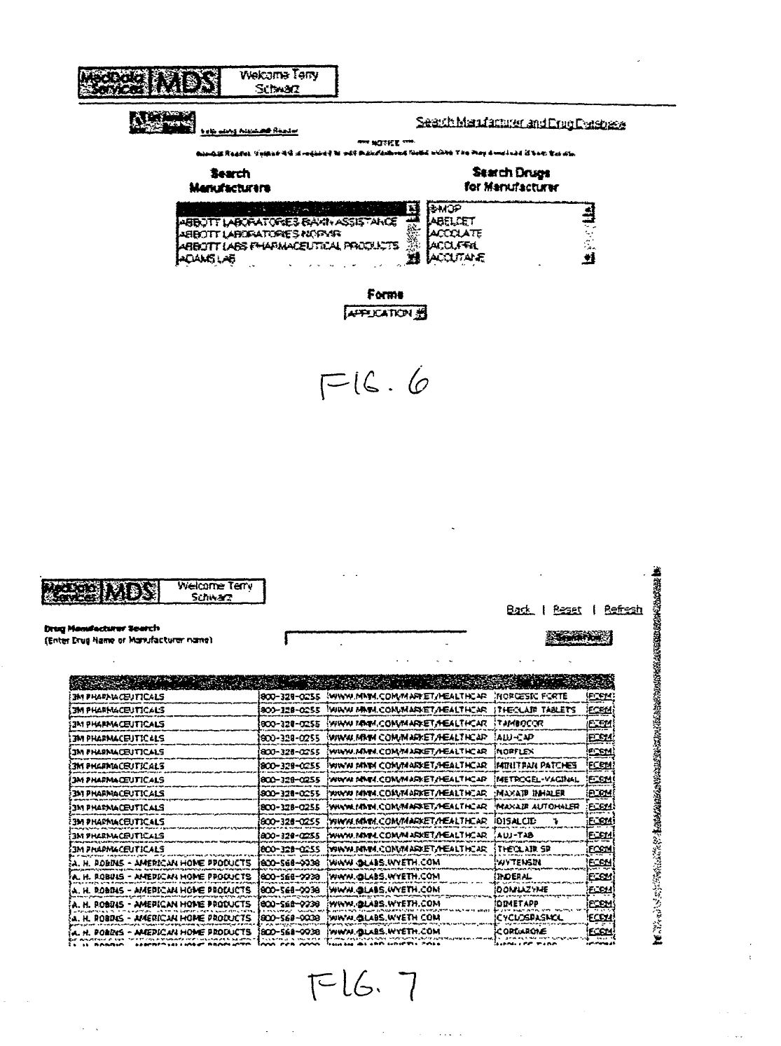

An example of a search screen is shown in FIG. 5. Upon selecting the menu option “Prescription Assistance Program Form” the user is presented with two list boxes to aid in finding the correct form. If the user knows the manufacturer, then the user may click on the manufacturer's name. If the manufacturer is unknown, the user may click on the drug and the manufacturer will be automatically selected. The manufacturer will display a list box of forms associated with that manufacturer. Clicking on the forms will select and display the current form. An example of a “form found on screen” is shown in FIG. 6. The user also has the ability to search for forms in a grid style. The user may sort the database by clicking on the heading of any column displayed. An example of the database shown in grid style is shown in FIG. 7.

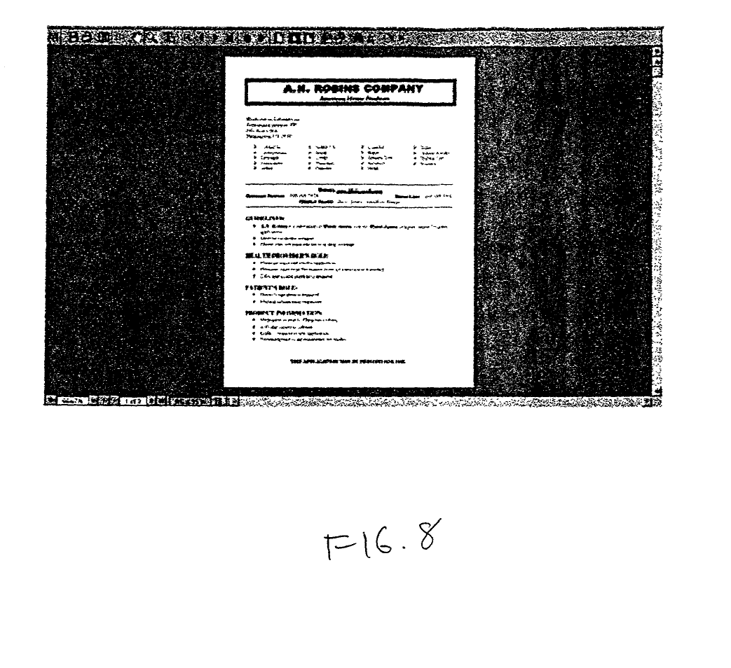

Once a form has been selected the user may print out a blank form or the user may type the information directly on the form and print the completed form. Data typed into the form can be saved so that the user can make modifications at a later date. An example of a display showing a selected form is shown in FIG. 8.

The user may select the instructions page 36 by clicking a hyperlinked graphics or text statement at several different locations on the site. The request forwarded to the web server includes a parameter specifying the selected manufacturer. The server at 42 performs an ADO/SQL retrieval based on this parameter and redirects the user to a PDF file that stores the manufacturer's Instruction Page. A suitable software, such as the Adobe Acrobat, Adobe Systems, Inc., must be used by the user in order to view the file at 44.

The user accesses the manual fill page 40 by clicking the “Manual Fill” hyperlinked graphic on the Program Forms Page 24. The request forwarded to the web server includes a parameter specifying the selected manufacturer. The server performs at 46 an ADO/SQL retrieval based on this parameter and redirects the user to a PDF file that stores a blank copy of the manufacturer's Fill-In Form. A suitable software, such as the Adobe Acrobat, Adobe Systems, Inc., must be used by the user in order to view the form at 48 and print it out so that the user can manually fill it in and fax it to the appropriate location.

The Auto Fill Page 38 is an ASP/Javascript/HTML page initially accessed by clicking the “Auto Fill” hyperlinked graphic on the Program Forms Page 24. When the user initially requests this page, the web server returns a page containing the following elements:

A Doctor Selection web form that enables searching and selecting a doctor. The search feature at 50 is implemented similarly to the one discussed on the Program Forms Page 24. When this page is requested, the web server uses the session variable stored on the User ID to execute an ADO/SQL retrieval of an alphabetical list of doctors related to the user. The web server uses this data to populate the doctor select list.

A similar Patient Selection web form at 50 that enables searching and selecting a patient which is populated with the results of an ADO/SQL retrieval of user-related patients.

A Prescription web form that enables the user to identify the doctor, patient, and manufacturer associated with the prescription to be created. At the top of the form is a user-changeable checkbox to indicate whether the user desires to update the Tracking Program upon submission of the Prescription form. Also, whenever this page is requested, the web server looks for a parameter in the request that specifies the manufacturer of interest and automatically includes the manufacturer's name in a form element toward the bottom of the form.

The Auto Fill feature at 52 of this page is implemented as follows using data stored in the database 53:

The Doctor Selection, Patient Selection and Prescription forms are initially blank.

Double clicking a doctor in the list, reloads the page and provides the web server with a parameter identifying the doctor selected. The web server uses this parameter to execute an ADO/SQL retrieval of the selected doctor's data and auto fills the Prescription Form accordingly. Double-clicking the patient in the list is implemented similarly.

Once the prescription form contains data, a hyperlinked graphic at 54 is made visible for form submission. Prior to submission, Javascript functions perform form validation with appropriate error messages and user prompts.

When the Prescription form is submitted, the AutoFill Page 38 is reloaded. Additional hyperlinked text statements take the place of the Prescription form as follows:

A hyperlinked statement that accesses the manufacturer's Instruction Page is visible near the center of the reloaded AutoFill Page 38.

A hyperlinked statement that accesses the Prescription Form Page 56 is visible on the right of the page. If the checkbox directing storage of this prescription in the Tracking Program was checked prior to submission, this statement includes word to that effect. If not, the user is reminded that the Tracking Program was not updated.

The Prescription Form Page 56 may be accessed by clicking the appropriate hyperlinked text statement on the Auto Fill Page 38. The request forwarded to the web server includes parameters specifying all of the information recorded in the Prescription Form on the Auto Fill Page 38. The server redirects the user to a PDF file that stores a copy of the manufacturer's Fill-In Form which is automatically filled with the appropriate data from the Prescription Form. A suitable software, such as the Adobe Acrobat, Adobe Systems, Inc., must be used by the user in order to view the form 58, edit the content that was autofilled and print it. The user can then complete the form (with signature, if required) and send it to the appropriate location.

The poverty guideline page 28 is an HTML-only page. This HTML-only page contains a table detailing the US Federal Poverty Guidelines for the 48 Contagious States, Alaska and Hawaii. These guidelines are frequently referenced in eligibility criteria for the prescription assistance program provided by pharmaceutical companies. A hyperlinked graphic at the bottom of the page returns the user to the Program Forms Page 24.

The doctor information pages 30 are several ASP/Javascript/HTML hyperlinked pages. This is the first of several ASP/Javascript/HTML hyperlinked pages used to review, add, edit and delete doctor entries in the SQL database. The series of pages are implemented as follows:

When the Doctor Information Page 30 is requested, an alphabetical listing of the doctors in the SQL database having the User ID of the current user(i.e., the session variable created when the user logged into the site) is obtained via an ASO/SQL retrieval. The web server uses ASP scripting to place this listing into an HTML table with the first column of the table holding hyperlinked last names.

The page also loads with a group of graphic button above the table. These buttons implement the following features:

The top button labeled “Add Doctor” accesses the Insert Doctor Page used to add the doctors to the SQL database. This page opens with an empty web form in which the user can record the appropriate data and insert a new doctor into the SQL database. Embedded Javascript functions validate form entries before the data is submitted to the SQL database.

The second tier series of bottons (First 10 Records, etc.) reload this page using ASP scripting with ADO methods to page through the list of retrieved doctors displaying 10 records at a time.

Clicking a doctor's last name in the table accesses the Edit Doctor Page. Requesting this page initiates an ADO/SQL retrieval of the selected doctor's data from the SQL database and displays the data for editing in a web form. The user has two choices on this page to modify doctor information in the SQL database:

The user can modify the data displayed in the web form and click the “Update” button. This action directs the web server to execute an ASP script-only page that implements an “UPDATE” SQL statement to alter the stored data on the doctor.

The user can click a “Delete Doctor” button at the top of the page. This action directs the web server to execute an ASP script-only page that implements a “DELETE” SQL statement to remove the doctor from the database.

The patient information pages 32 are a series of ASP/Javascript,/HTML pages which are used to review, add, edit, and delete patient entries in the SQL database. They are implemented similarly to the Doctor Information Page(s) 30 described above.

The Tracking System Entry Page 26 is an HTML-only page presented to the user with a personalized greeting and three hyperlinked graphics that provide the user during navigational choices:

Add a Record to the Tracking System. Clicking this choice accesses the Add Tracking Record Page 70.

Edit an Existing Record in the Tracking System. Clicking this choice accesses the Search Tracking Records Page 72.

Create a Report. Clicking this choice accesses the Tracking Reports Page 74.

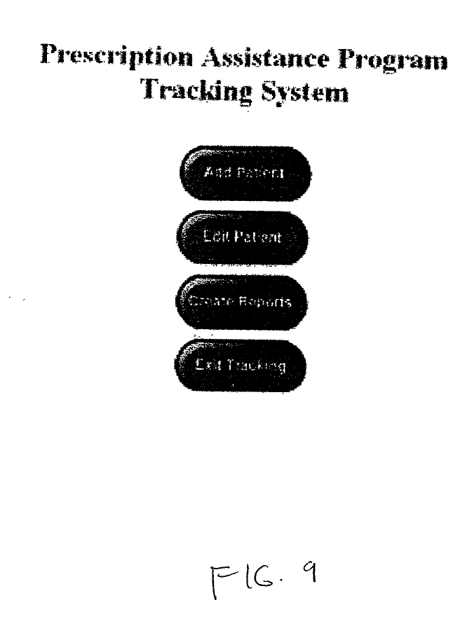

An example of the tracking system entry page 26 is shown in FIG. 9.

The Add Tracking Record Page 70 is an ASP/Javascript/HTML page containing a form for the user to complete with information on a new tracking system record. When the page 70 is requested, the web server uses the session variable “User ID” to perform an ADO/SQL retrieval of an alphabetical list of clinics for that user. This list is used to fill the Clinic select list on the form. The web server similarly uses an ADO/SQL retrieval of an alphabetical list of manufacturers to fill the Manufacturer list on the form.

Javascript functions are used to implement a calendar object on the page as follows:

When the page loads, a series of Javascript routines are run that dynamically build the current months's calendar in a form that is hidden at the bottom of the page. When the user clicks any of the calendar graphics that are adjacent to one of the date fields on the form, a Javascript function changes the visibility attribute of the calendar form to “show” and positions the calendar form on the page based on which date field was chosen. Once the calendar is visible, two select lists at the top of the calendar form enable a user to select a different month and year. Changing either list triggers a series of Javascript functions that rebuild the calendar form accordingly. Clicking a date on the calendar form triggers a Javascript function that places the selected date in the appropriate date field and then hides the calendar form.

Once the user has filled in form data elements, the hyperlinked graphics at the bottom of the page present two choices to the user.

Save the Information. Clicking this graphic triggers Javascript form validation routines. If successful, the form elements are sent to an ASP-only page that performs an “INSERT INTO” SQL statement to store the new record in the Prescription table of the SQL database. After this is done, the user is redirected to a page summarizing the record that was added.

Calculate Dates. clicking this graphic triggers a series of Javascript functions that compute and set the Renewal and Refill dates on the form.

An example of an “add tracking record” page 70 is shown in FIG. 10. Input screen displays the users company they are keyed to while entering information. Clinics are keyed to users and only show clinics available to the current company. Upon completion of data input, user can press calculate press button. Calculating dates will give the customer/client the benefit of knowing when it is time to renew their application. The Expiration Date field lets the client know that their pills will run out on the day. The renewal date is a date in which to remind the client that it is time to mail in the renewal application so that they will not run out of medications. The renewal date also gives the client a week leeway time in order to get the application letter back on time.

The expiration date=rx_date+days Supply.

The renewal date=(expiration date)−(confirmation letter date−application date)+7.

The Search Tracking Records Page 72 is a Javascript/HTML page containing forms that present two navigational choices to the user:

Search for Tracking records based on a Patient ID.

Search for Tracking records based on Patient Name.

In both cases, the search is bounded by a date range entered by the user and form validation is performed by Javascript routines prior to form submission. The user can use the calendar form as explained under the Add Tracking Record Page 70. Completing and submitting either form accesses the Tracking Search Results Page 76.

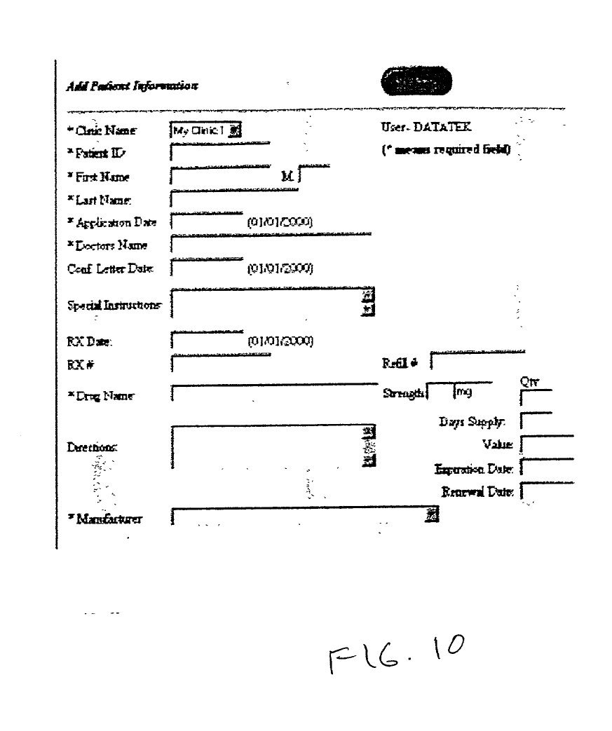

An example of a search screen is shown in FIG. 11. The patient is located in the database by inputting the patient ID and a date range when the patient was entered or by inputting patient name and a date range when the patient was entered then pressing the search button.

The Search Results Page 76 is an ASP/Javascript/HTML page presenting the user with a listing of tracking records that meet the criteria requested by the user on the search tracking records page 72. When this page is requested, the web server performs an ADO/SQL retrieval of all prescriptions that meet the search parameters submitted from the Search Tracking Records Page 72. The SQL statement used allows partial text searches for any or all of Patient ID, Last Name, First Name, and Middle Name fields. The ASP script builds the specified listing in an HTML table that includes data from the appropriate prescriptions and hyperlinks each Record ID to an Edit Tracking Record Page. When the user clicks the link, this page is accessed to enable editing of the chosen record.

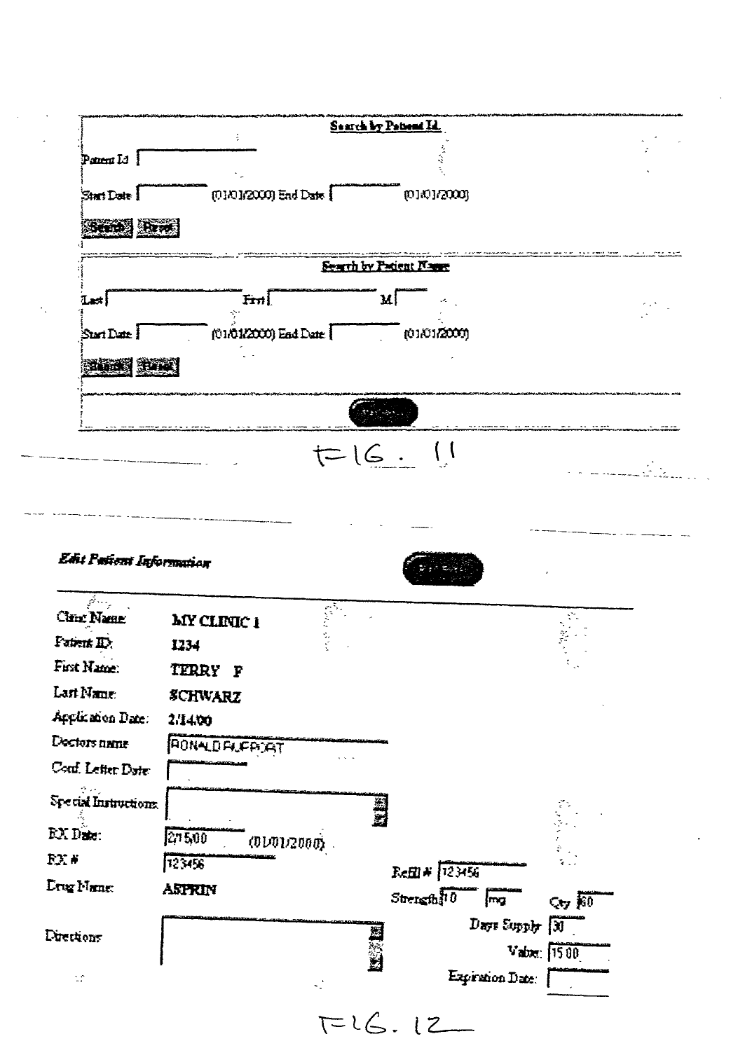

An example of an Edit Patient Information Screen is shown in FIG. 12. This page allows users to change or add information to a patient's record. Fields that can be changed are: Doctors Name, Confirmation Date, Special Instructions, RX Date, Directions, Refill Number, Drug Strength, Quantity, Days Supply, Value.

Expiration and Renewal Dates are automatically calculated. Calculating dates will give the customer/client the benefit of knowing when it is time to renew their application. The Expiration Date field lets the client know that their pills will run out on that day. The renewal date is a date in which to remind the client that is its time to mail in the renewal application so that they will not run out of medications. The renewal date also gives the client a week leeway time to order to get the application letter back on time.

The expiration date=rx_date+days Supply.

The renewal date=(expiration date)−(confirmation letter date−application date)+7

The Tracking Reports Page 74 is an HTML-only page presenting to the user five hyperlinked graphics providing navigational choices as follows:

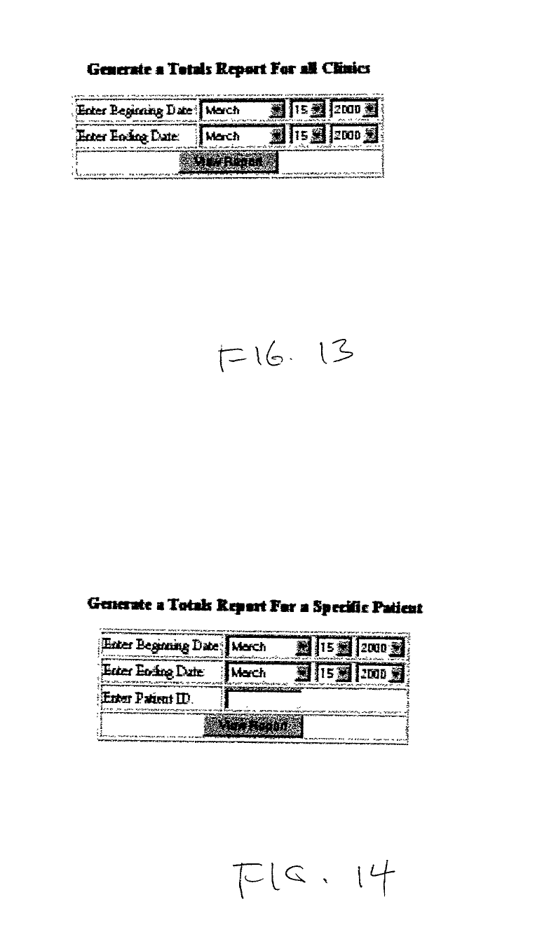

View Report on Running Totals for Clinics. Clicking this graphic presents the user with a form, as shown in FIG. 13, for selecting a date range. Once the criteria has been selected, clicking the “View Report” graphic directs the web server at 78 to execute an ADO/SQL retrieval of the appropriate data and present the results at 80 using a CRYSTAL REPORTS v.8.0 report generator.

View Report on Running Totals for a Clinic. Clicking this graphic presents the user with a form for selecting a date range and specifying a particular clinic. Once the criteria has been selected, clicking the “View Report” graphics directs the web server at 78 to execute an ADO/SQL retrieval of the appropriate data and present the results at 80 in CRYSTAL REPORTS v.8.0 report generator.

View Report on Running Totals for a Patient. Clicking this graphic presents the user with a form, as shown in FIG. 14, for selecting a date range and specifying a particular patient. Once the criteria has been selected, clicking the “View Report” graphics directs the web server at 78 to execute an ADO/SQL retrieval of the appropriate data and present the results at 80 in CRYSTAL REPORTS v.8.0 report generator.

View Report on Expiration Dates for a Clinic. Clicking this graphic presents the user with a form for selecting a date range and specifying a particular clinic. Once the criteria has been selected, clicking the “View Report” graphics directs the web server at 78 to execute an ADO/SQL retrieval of the appropriate data and present the results at 80 in CRYSTAL REPORTS v.8.0 report generator.

View Report on Renewal Dates for a Clinic. Clicking this graphic presents the user with a form for selecting a date range and specifying a particular clinic. Once the criteria has been selected, clicking the “View Report” graphics directs the web server to execute an ADO/SQL retrieval of the appropriate data and present the results in CRYSTAL REPORTS v.8.0 report generator.

While this invention has been described as having preferred design, it is understood that it is capable of further modification, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

We claim:

1. An online system for providing prescription assistance for indigent patients using programs provided by pharmaceutical manufacturers, comprising:
a) a web server connected to the internet;
b) a database connected to said web server, said database including names of manufacturers of drugs providing prescription assistance to indigent patients and their respective application forms required to be filled out and submitted to the manufacturer to participate in the programs;
c) al least one workstation connected to said web server through the internet; and
d) software operably associated with said web server and said database for searching the database for an application form by a user located at said at least one workstation by selecting manufacturer name or drug name, for viewing the forms on a monitor, for filling out the form for a patient and printing the form for sending to the manufacturer.

2. A system as in claim 1, wherein said software further includes means tracking the patient's renewal date for prescription.

3. A system as in claim 1, wherein said software further includes means for manually filling out the form on the monitor.

4. A system as in claim 1, wherein said software further includes means for auto-filling the form.

5. A system as in claim 1, wherein said applications forms are stored in PDF files.

6. A method for providing prescription assistance for indigent patients using programs provided by pharmaceutical manufacturers, comprising:
a) establishing a database including names of manufacturers of drugs providing prescription assistance to indigent patients and their respective application forms required to be filled out to participate in the programs;
b) connecting the database online to a user;
c) searching the database by the health care provider for an application form by selecting manufacturer name or drug name;
d) viewing the form associated with selected manufacturer or drug on a monitor;
e) filling out the form for a patient and printing the form for sending to the manufacturer.

7. A method as in claim 6, and further comprising tracking a date to remind the health care provider to file a renewal application for the patient.

8. A method as in claim 6, wherein said filling the form is implemented by manually filling out the form on the monitor.

9. A method as in claim 6, wherein said filling out the form is implemented by means for auto-filling the form.

10. A website for providing prescription assistance for indigent patients using programs provided by pharmaceutical manufacturers, comprising:
a) a login page for a user to register;
b) a registered user's page displayed to the user when the user's login is accepted;
c) a program forms page accessible from said registered user's page, said program forms page including a list of manufacturers and drugs to aid in finding a form required to be filled out and submitted to the manufacturer to participate in the programs; and
d) a manual fill page accessible from said program forms page, said manual fill page displaying a selected manufacturer's blank form adapted to be filled out and printed for sending to the manufacturer.

11. A website as in claim 10, and further comprising:
a) a tracking system entry page accessible from said registered user's page, said tracking system entry page for inputting patient information regarding prescription expiration date to calculate a renewal date for the patient.

12. A website as in claim 11, wherein:
a) said tracking system entry page further including means for generating reports showing activities for a specific patient.

13. A website as in claim 11, wherein:
a) said tracking system entry page further including means for generating reports showing activities for a clinic.

14. A website for providing prescription assistance for indigent patients using programs provided by pharmaceutical manufacturers, comprising:
a) a login page for a user to register;
b) a registered user's page displayed to the user when the user's login is accepted;
c) a program forms page accessible from said registered user's page, said program forms page including a list of manufacturers and drugs to aid in finding a form required to be filled out and submitted to the manufacturer to participate in the programs; and
d) an autofill page accessible from said program forms page, said autofill page including means for filling out a selected application form and displaying the completed form.

15. Software for providing prescription assistance for indigent patients using programs provided by pharmaceutical manufacturers, comprising:
a) a database including names of pharmaceutical manufacturers providing programs for indigent patients, their respective drugs which they distribute and their respective forms required to be filled out to participate in the programs;
b) means for allowing online access by a user to the database; and
c) means for allowing a user to search online for a form by selecting manufacturer name or drug name, to view and fill out the form on a screen and to print the form.

16. A software as in claim 15, and further comprising:
a) means for tracking online by a user a patient's prescription renewal date.

17. A software as in claim 16, and further comprising:
a) means for generating a report online on patient activity.

18. A software as in claim 15, and further comprising means for manually filling out the form on the screen.

19. A software as in claim 15, and further comprising means for autofilling the form.
